(19) United States
(12) Patent Application Publication
(10) Pub. No.: US 2024/0330600 A1
(43) Pub. Date: Oct. 3, 2024

(54) TYPE-SPECIFIC NATURAL LANGUAGE GENERATION FROM TABULAR DATA

(71) Applicant: INTERNATIONAL BUSINESS MACHINES CORPORATION, Armonk, NY (US)

(72) Inventors: Yotam PERLITZ, Tel Aviv (IL); Michal SHMUELI-SCHEUER, Tel Aviv (IL); Liat EIN-DOR, Tel Aviv (IL); Dafna SHEINWALD, Nofit (IL); Noam SLONIM, London (GB)

(21) Appl. No.: 18/128,269

(22) Filed: Mar. 30, 2023

(51) Int. Cl. G06F 40/40; G06F 40/157; G06F 40/30

(52) U.S. Cl. CPC G06F 40/40; G06F 40/157; G06F 40/30

(57) ABSTRACT

A table-to-text (T2T) generation model provides type control and semantic diversity. A method, system, and computer program product are configured to: train a model to generate one or more logic-type-specific natural language statements based on tabular data; in response to receiving a first input comprising first input data with a user-specified logic-type, the trained model generating a first logic-type-specific natural language statement based on the first input data and the user-specified logic-type; and in response to receiving a second input comprising second input data without a user-specified logic-type, the trained model generating plural second logic-type-specific natural language statements based on the second input data, wherein respective ones of the second logic-type-specific natural language statements are generated according to respective ones of plural predefined logic-types.

### STATEMENT REGARDING PRIOR DISCLOSURES BY THE INVENTOR OR A JOINT INVENTOR

The following disclosure(s) are submitted under 35 U.S.C. 102(b)(1)(A): DISCLOSURES: Perlitz et al., “Diversity Enhanced Table-to-Text Generation via Type Control,” submitted on May 22, 2022, 8 pages, listed in and provided with an Information Disclosure Statement accompanying this application.

### BACKGROUND

Aspects of the present invention relate generally to natural language generation and, more particularly, to computer-based generation of natural language statements from tabular data.

Table-to-text (T2T) generation is the task of computer-based generation of natural language statements to convey information appearing in tabular data. This task is usable in real-world scenarios including generation of weather forecasts, sport results, and more. A statement generated from tabular data can be inferred based on different levels of information. These range from the value of a specific cell to the result of logical or numerical operations across multiple cells, such as the average value of a column, or a comparison between rows.

### SUMMARY

In an aspect of the invention, there is a method including: training a model to generate one or more logic-type-specific natural language statements based on tabular data; in response to receiving a first input comprising first input data with a user-specified logic-type, the trained model generating a first logic-type-specific natural language statement based on the first input data and the user-specified logic-type; and in response to receiving a second input comprising second input data without a user-specified logic-type, the trained model generating plural second logic-type-specific natural language statements based on the second input data, wherein respective ones of the second logic-type-specific natural language statements are generated according to respective ones of plural predefined logic-types.

In another aspect of the invention, there is a computer program product including one or more computer readable storage media having program instructions collectively stored on the one or more computer readable storage media. The program instructions are executable to: train a model to generate one or more logic-type-specific natural language statements based on tabular data; in response to receiving a first input comprising first input data with a user-specified logic-type, the trained model generating a first logic-type-specific natural language statement based on the first input data and the user-specified logic-type; and in response to receiving a second input comprising second input data without a user-specified logic-type, the trained model generating plural second logic-type-specific natural language statements based on the second input data, wherein respective ones of the second logic-type-specific natural language statements are generated according to respective ones of plural predefined logic-types.

In another aspect of the invention, there is a system including a processor set, one or more computer readable storage media, and program instructions collectively stored on the one or more computer readable storage media. The program instructions are executable to: train a model to generate one or more logic-type-specific natural language statements based on tabular data; in response to receiving a first input comprising first input data with a user-specified logic-type, the trained model generating a first logic-type-specific natural language statement based on the first input data and the user-specified logic-type; and in response to receiving a second input comprising second input data without a user-specified logic-type, the trained model generating plural second logic-type-specific natural language statements based on the second input data, wherein respective ones of the second logic-type-specific natural language statements are generated according to respective ones of plural predefined logic-types.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a diagram of exemplary training of a model in accordance with aspects of the present invention.

FIG. 4 shows a diagram of exemplary use of a model in accordance with aspects of the present invention.

FIGS. 5 and 6 show exemplary use cases in accordance with aspects of the present invention.

FIG. 7 shows a flowchart of an exemplary method in accordance with aspects of the present invention.

### DETAILED DESCRIPTION

Aspects of the present invention relate generally to natural language generation and, more particularly, to computer-based generation of natural language statements from tabular data. Aspects of the invention provide a table-to-text (T2T) generation model that is controlled by logic-type and that supports better diversification and controllability in T2T generation. By producing a diverse set of statements, each generated controlled by a different logic-type, the model enables diversity enhancement via type control. Controllability is facilitated by the model enabling users to guide the model to generate statements of specific type(s), out of the many different valid statements that may correspond to the input table. Embodiments may be used to generate a diverse set of high-quality statements, each tuned by logic-type, without suffering any degradation in quality. Embodiments may also be used to generate statements according to a user-specified logic-type.

A complex insight extracted from structured data (e.g., such as tabular data) belongs to one of a few logic inference types based on the logical operation taken on the structured data in order to obtain the insight. Current insight extraction methods either (1) cannot control insight type or (2) over-specify the insight thereby making the specification too elaborate for a user or automated system to generate. For example, complex insight extraction methods that do not specify a logic inference type suffer from reduced user interest since these methods extract insights with a random logic inference type regardless of the user preference. These methods suffer from reduced coverage since they extract a single logic inference type insight even though many different types are present in, and can be extracted from, the data. Conversely, complex insight extraction methods that over-specify a logic inference type suffer from inapplicability since the required specification is too complex for users and automatic systems. Template based methods offer low fluency and diversity.

Implementations of the invention address these problems by providing a table-to-text (T2T) generation model that is trained using logic-types as an input, and wherein the natural language statements generated by the model are specific to one of the logic-types. In embodiments, after being trained in this manner, the model may receive a user-specified logic-type and generate a natural language statement from structured data based on the user-specified logic-type. The trained model may also, in the absence of a user-specified logic-type, generate plural different natural language statements from structured data, where each of the statements is specific to a different one of plural logic-types. In this manner, implementations of the invention provide a T2T generation model that advantageously enables both type-control (e.g., when a user specifies a logic-type) and semantic diversity (e.g., when a user does not specify a logic-type) when generating natural language statements based on tabular data.

Embodiments train a T2T generation model (also called a sequence-to-sequence model) to minimize some loss over generated and reference insights that are generated against an input of both the structured data and the logic-type. The trained model may then be used to extract insights for a user-specified logic-type, or to extract a large variety of insights that increase the coverage. The trained model is able to deliver controllability to a user over the generated insights that no other neural model can obtain. The trained model can also deliver better coverage as the system can be tuned to extract many types as a preset.

Embodiments include training a neural model (e.g., an artificial neural network model) to generate statements from a table while also inputting a required logic-type of the statement. The model is thus trained to generate a statements from a table with a controlled logic-type for the generated statements. The trained model can be used to: (1) automatically generate statements in a logic-type as requested by the user, and (2) automatically generate a large set of semantically diverse statements according to different logic-types from which the user can choose.

As will be understood from the present disclosure, an embodiment provides for a system, method, and computer program product that are configured to generate controlled type natural language insights from tables to improve coverage and quality. Given an input data-table, embodiments either produce multiple statements representing different types of insights about the table or statements of specific types as requested by the user. Embodiments leverage text classification methods for augmenting table-to-text datasets with logic-type annotations and use the resultant datasets to train the logic-type-specific complex insight extraction neural model with the cross-entropy loss. Embodiments use the trained logic-type-specific complex insight extraction model in a diversity enhancing scheme to obtain greater coverage of insights all while keeping quality levels above those of other methods that offers less coverage and no control.

Implementations of the invention are necessarily rooted in computer technology. For example, the steps of (i) training a model to generate one or more logic-type-specific natural language statements based on tabular data and (ii) using the trained model to generate one or more logic-type-specific natural language statements based on tabular data are computer-based and cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted. e.g., via backpropagation or stochastic gradient descent or Adam optimizer, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by or obtained from individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as statement generation code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

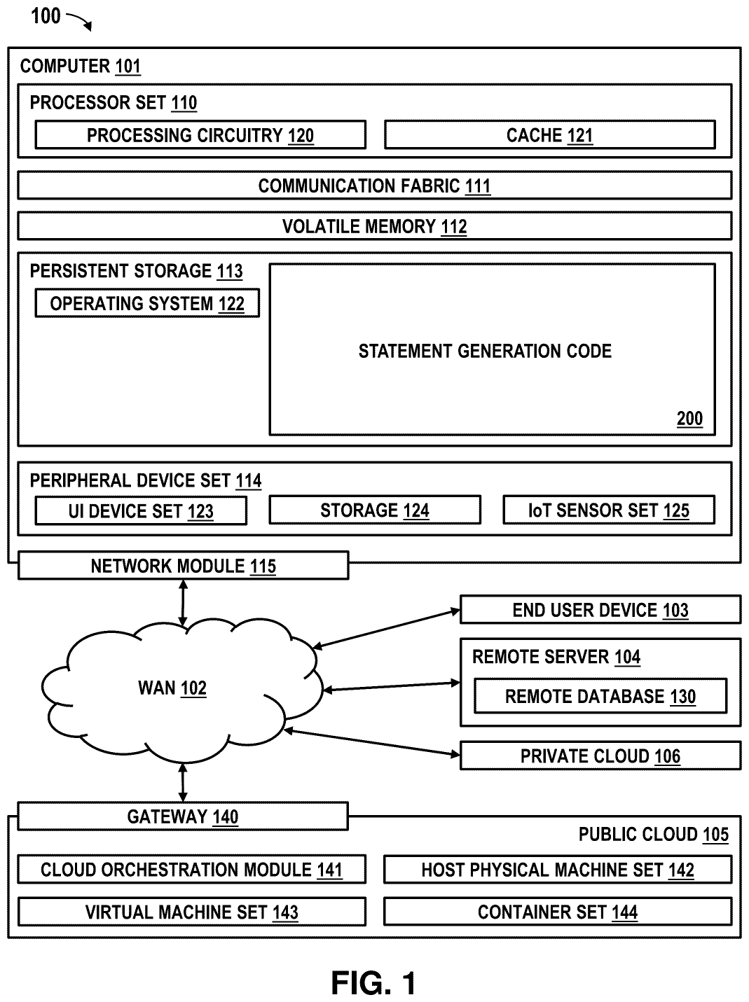

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

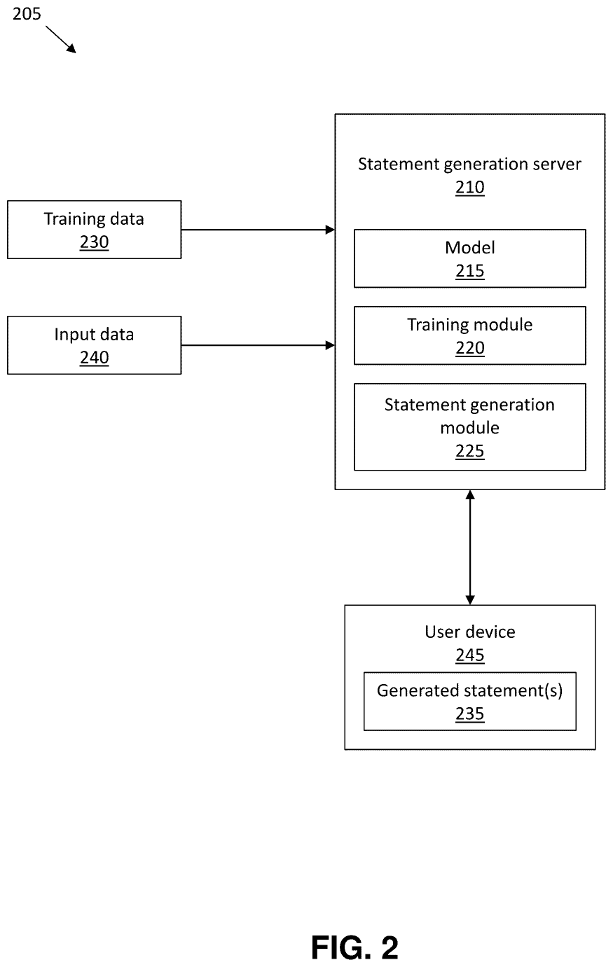

FIG. 2 shows a block diagram of an exemplary environment 205 in accordance with aspects of the invention. In embodiments, the environment 205 includes a statement generation server 210 that is configured to train and use a model 215 to generate logic-type-specific natural language statements based on tabular input data.

In embodiments, the server 210 runs the statement generation code 200 of FIG. 1. The server 210 may comprise one or more instances of computer 101 of FIG. 1. The server 210 may alternatively comprise one or more virtual machines or one or more containers running on one or more instances of computer 101 of FIG. 1. In embodiments, the server 210 of FIG. 2 comprises a training module 220 and a statement generation module 225, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

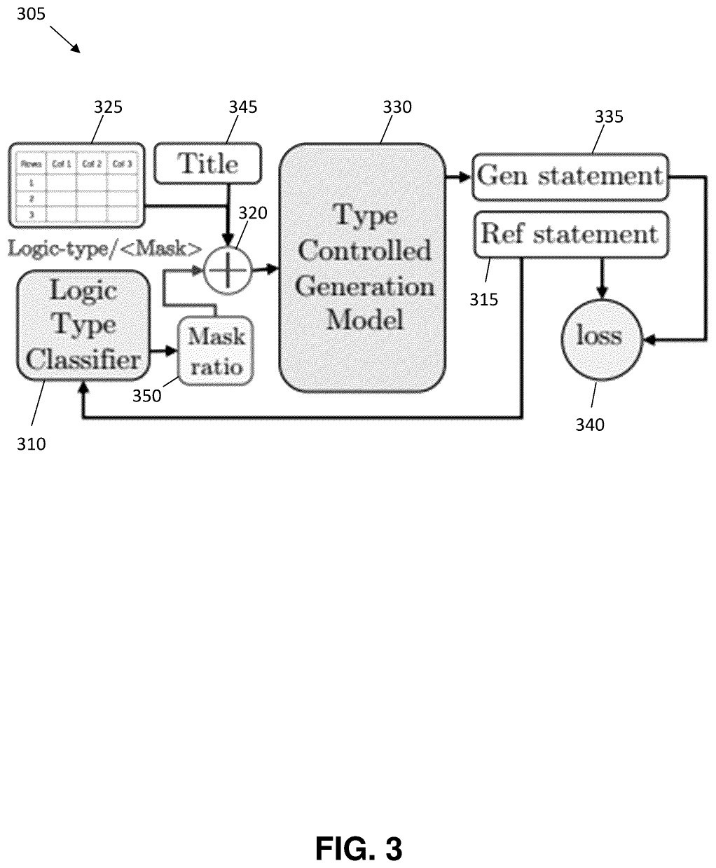

In accordance with aspects of the invention, the training module 220 is configured to train the model 215 using training data 230 and machine learning training algorithms. In embodiments, the model 215 comprises a machine learning model that is trained to generate one or more natural language statements based on receiving tabular data as input, where the statements are generated from the data according to one or more predefined logic-types (referred to herein as logic-type-specific). In embodiments, the model 215 comprises an artificial neural network. In one example, the model 215 comprises a transformer neural network that is trained using Adam optimizer and autoregressive cross entropy loss. Once trained, data defining the model 215 may be stored at the server 210 or at a network location accessible by the server 210. Exemplary training of the model 215 is described with respect to FIG. 3.

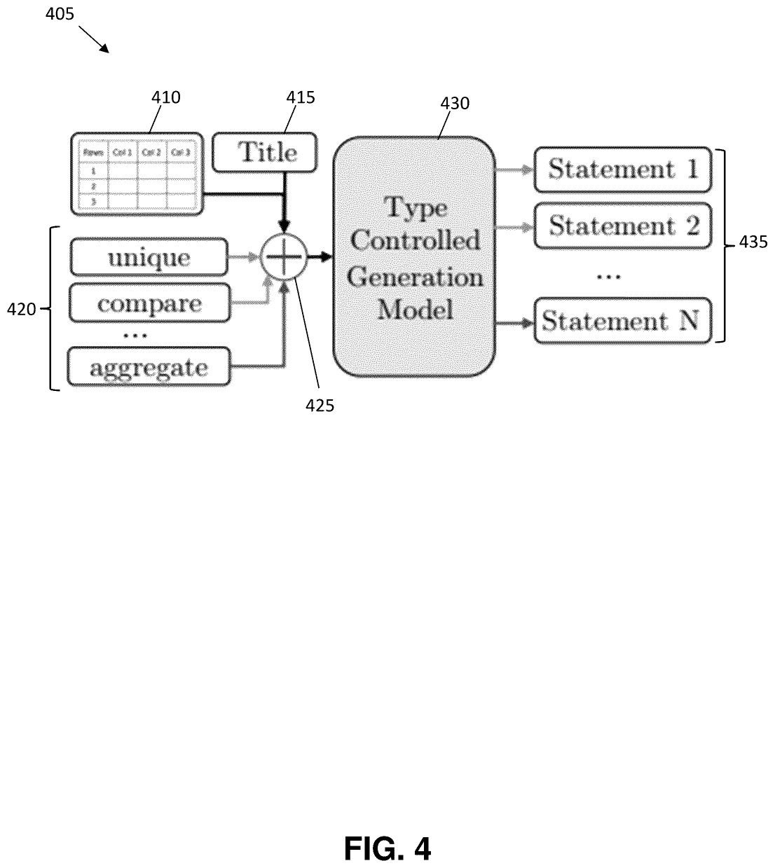

In accordance with aspects of the invention, the statement generation module 225 is configured to use the trained model 215 to generate one or more logic-type-specific natural language statements 235 based on input data 240. In embodiments, each of the generated statements 235 is based on an insight extracted from the input data 240. In embodiments, each of the generated statements 235 is logic-type-specific, meaning that each of the generated statements 235 has a semantic structure according to one of plural predefined logic-types on which the model 215 is trained. In embodiments, the input data 240 comprises structured data, such as tabular data. In this manner, the model 215 comprises a table-to-text (T2T) generation model. Exemplary use of the model 215 is described with respect to FIG. 4.

With continued reference to FIG. 2, the environment 205 may comprise one or more user devices 245. In embodiments, the user device 245 is configured to specify the input data 240 used by the model 215 and to display the generated statements 235 created by the model 215 based on the specified input data 240. The user device 245 may also be used to input a user-specified logic-type that is used by the model 215 with the input data 240.

In an exemplary implementation, the user device 245 comprises the end user device 103 of FIG. 1 and the server 210 communicates with the user device 245 via the WAN 102 of FIG. 1. The training data 230 and/or the input data 240 may be provided to the server 210 by the user device 245 or may be stored remotely, such as at remote server 104 or public cloud 105 of FIG. 1 and accessed by the server 210 via the WAN 102.

FIG. 3 shows a diagram 305 that illustrates exemplary training of the model 215 of FIG. 2 in accordance with aspects of the present invention. In embodiments, the training module 220 (now shown) trains the model 215 by: annotating tabular training data (e.g., tabular data from the training data 230) with a predicted one of plural predefined logic-types predicted from a reference statement; using the model to create a generated statement from the annotated tabular training data; determining a loss based on comparing the generated statement to the reference statement; and adjusting the model based on the loss. In embodiments, the plural predefined logic-types comprise count, comparative, superlative, unique, ordinal, aggregation, and majority.

In the example shown in FIG. 3, at block 310 the training module 220 uses a logic-type classifier to predict one of the plural predefined logic-types based on a reference statement 315. The logic-type classifier may comprise a text-based classifier that is trained to determine one of the plural predefined logic-types based on the text and structure of the reference statement (e.g., using natural language processing). For example, the logic-type classifier may comprise a BERT (Bidirectional Encoder Representations from Transformers) based classifier.

At block 320, the training module annotates the predicted logic-type from block 310 to tabular training data 325 by concatenating the predicted logic-type to the tabular training data 325. At block 330, the model being trained (e.g., model 215) receives the annotated tabular training data as input and generates a generated statement 335 based on this input. At block 340, the training module determines a loss based on a difference between the generated statement 335 and the reference statement 315. The training module 220 then adjusts one or more parameters of the model 215 based on the loss, e.g., using one or more machine learning training algorithms that are configured to minimize the autoregressive cross entropy loss between the generated and reference tokens.

In embodiments, the tabular training data 325 may comprise a title 345 that the training module 220 analyzes for context such as date and location associated with the tabular training data. This context may be included as an input to the model with the annotated tabular training data.

In embodiments, to add robustness for scenarios where logic-type is unavailable, the training module 220 masks the predicted logic-type from block 310 based on a mask ratio at block 350. Masking the predicted logic-type in this manner trains the model for situations where a logic-type is not included in the input. For example, when using the trained model, a user may elect to not specify a logic-type with the input. The model is trained to handle this scenario by sometimes masking the predicted logic-type during the training, e.g., based on the mask ratio.

FIG. 4 shows a diagram 405 that illustrates exemplary use of the model 215 (of FIG. 2) in accordance with aspects of the present invention. Block 410 represents input data (e.g., input data 240 of FIG. 2) in the form of tabular data. The input data may include a title shown at block 415. Blocks 420 represent the plural predefined logic-types that a user may specify as input to the model.

In one example of use, when the user specifies one of the plural predefined logic-types of block 420, then at block 425 the statement generation module 225 (not shown) annotates (e.g., concatenates) the user-specified one of the plural predefined logic-types to the input data 410. In this example, at block 430 the statement generation module 225 inputs the annotated input data to the trained model (e.g., model 215), which generates a statement at block 435 based on the annotated input data. In this manner, when the user specifies one of the logic-types, the model generates a logic-type-specific natural language statement based on the tabular input data and the user-specified logic-type. This scenario provides the user with control for the logic-type of the output of the model.

In another example of use, when the user does not specify one of the plural predefined logic-types of block 420, then at block 425 the statement generation module 225 does not annotate the input data 410 with a logic-type. In this example, at block 430 the statement generation module 225 inputs the unannotated input data to the trained model (e.g., model 215), which generates plural different statements at block 435 based on the unannotated input data, where each of the generated statements is specific to one of the plural predefined logic-types. In this manner, when the user does not specify one of the logic-types, the model generates plural logic-type-specific natural language statements based on the input data, where respective ones of the plural logic-type-specific natural language statements are specific to respective ones of plural predefined logic-types. This exemplary use provides the user with diversity for the logic-type of the output of the model.

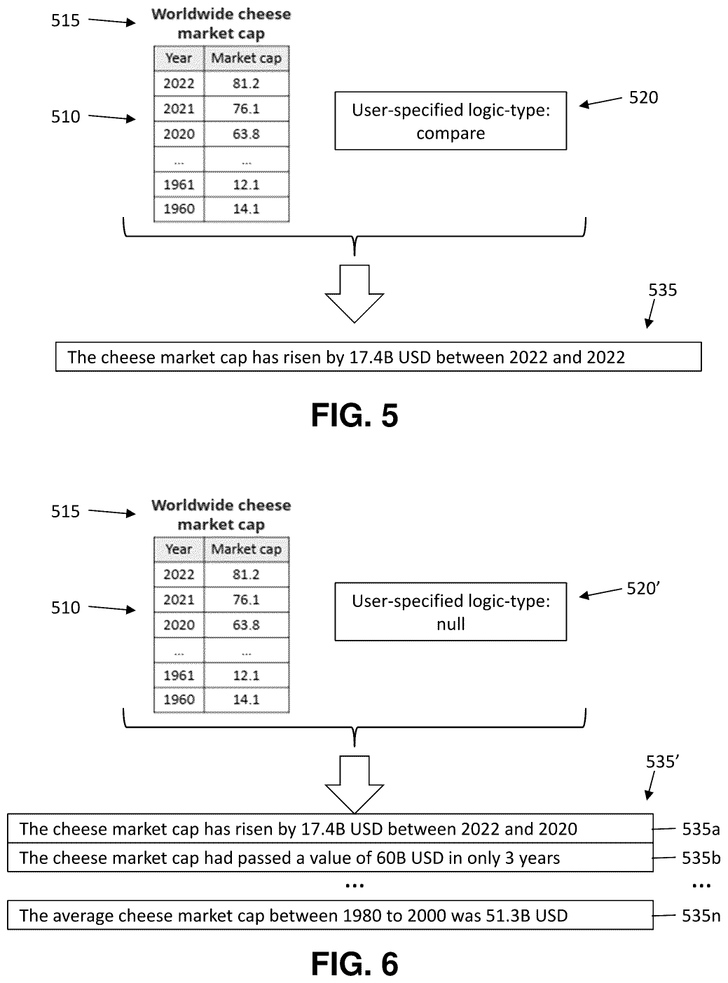

FIG. 5 shows an example of a first use case in which the user specifies a logic-type as an input for the model. In particular, FIG. 5 shows input data comprising tabular data 510 with a title 515, which corresponds to input data 410 and title 415 of FIG. 4. In FIG. 5, block 520 represents a user-specified logic-type. In this example, the user-specified logic-type is ‘compare’. In this example, the statement generating module 225 uses this input data (e.g., 510, 515, 520) with the trained model 215 to generate a single logic-type-specific natural language statement 535, where the statement 535 is of the same logic-type as that specified by the user (e.g., the logic-type ‘compare’ in this example).

FIG. 6 shows an example of a second use case in which the user does not specify a logic-type as an input for the model. In particular, FIG. 6 shows the same tabular data 510 with title 515. However, in FIG. 6, block 520′ shows that the user has not specified a logic-type (e.g., logic-type=null). In this example, the statement generating module 225 uses this input data (e.g., 510, 515) with the trained model 215 to generate a plural logic-type-specific natural language statements 535′, where different ones of the statements 535′ correspond to different ones of the plural predefined logic-types on which the model is trained. In this example, statement 535a has the logic type ‘compare’, statement 535b has the logic type ‘count’, and statement 535n has the logic type ‘aggregation’. In embodiments, the number ‘n’ equals the predefined logic-types on which the model is trained.

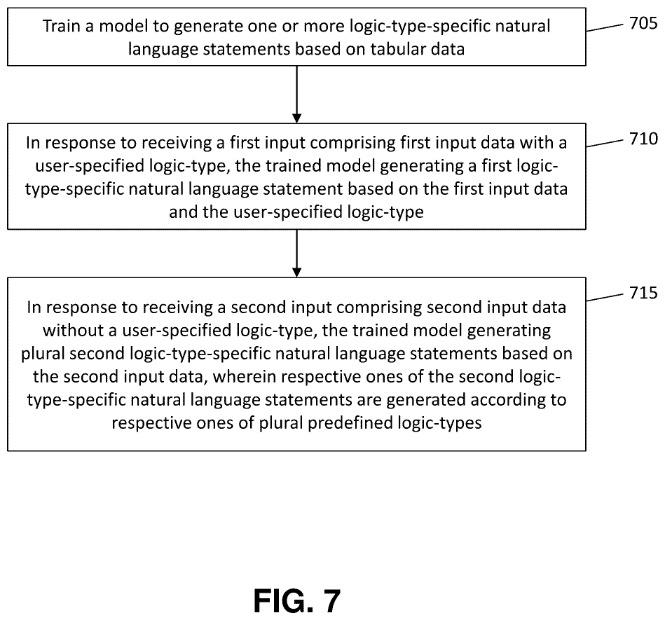

FIG. 7 shows a flowchart of an exemplary method in accordance with aspects of the present invention. Steps of the method may be carried out in the environment of FIG. 2 and are described with reference to elements depicted in FIG. 2.

At step 705, the system trains a model to generate one or more logic-type-specific natural language statements based on tabular data. Step 705 may be performed in the manner described with respect to FIGS. 2 and 3.

At step 710, in response to receiving a first input comprising first input data with a user-specified logic-type, the trained model generates a first logic-type-specific natural language statement based on the first input data and the user-specified logic-type. Step 710 may be performed in the manner described with respect to FIGS. 2, 4, and 5.

At step 715, in response to receiving a second input comprising second input data without a user-specified logic-type, the trained model generates plural second logic-type-specific natural language statements based on the second input data, wherein respective ones of the second logic-type-specific natural language statements are generated according to respective ones of plural predefined logic-types. Step 715 may be performed in the manner described with respect to FIGS. 2, 4, and 6.

In embodiments of the method, the model comprises a table-to-text (T2T) generation model that provides type control when the users specifies a logic-type and semantic diversity when the user does not specify a logic-type. In embodiments of the method, the first input data comprises first tabular data, and the second input data comprises second tabular data. The first tabular data and the second tabular data may be the same or different.

In embodiments of the method, training the model comprises annotating tabular training data with a predicted one of the plural predefined logic-types predicted from a reference statement. In embodiments of the method, the annotating comprises: determining the predicted one of the plural predefined logic-types from the reference statement using a text-based classifier; and concatenating the predicted one of the plural predefined logic-types to the tabular training data. In embodiments of the method, the training comprises: using the model to create a generated statement from the tabular training data annotated with the predicted one of the plural predefined logic-types; determining a loss based on comparing the generated statement to the reference statement; and adjusting the model based on the loss.

In embodiments of the method, the plural predefined logic-types comprise count, comparative, superlative, unique, ordinal, aggregation, and majority. In embodiments of the method, the model comprises an artificial neural network trained using cross entropy loss. The model may comprise a transformer neural network. The model may be optimized using an Adam optimizer technique.

In embodiments, the method further comprises: receiving the first input from a user device; and causing the user device to display the first logic-type-specific natural language statement in response to the first input.

In embodiments, the method further comprises: receiving the second input from a user device; and causing the user device to display the plural second logic-type-specific natural language statements in response to the second input.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
training a model to generate one or more logic-type-specific natural language statements based on tabular data;
in response to receiving a first input comprising first input data with a user-specified logic-type, the trained model generating a first logic-type-specific natural language statement based on the first input data and the user-specified logic-type; and
in response to receiving a second input comprising second input data without a user-specified logic-type, the trained model generating plural second logic-type-specific natural language statements based on the second input data, wherein respective ones of the second logic-type-specific natural language statements are generated according to respective ones of plural predefined logic-types.

2. The method of claim 1, wherein the model comprises a table-to-text (T2T) generation model that provides type control and semantic diversity.

3. The method of claim 1, wherein:
the first input data comprises first tabular data; and
the second input data comprises second tabular data.

4. The method of claim 1, wherein the training the model comprises annotating tabular training data with a predicted one of the plural predefined logic-types predicted from a reference statement.

5. The method of claim 4, wherein the annotating comprises:
determining the predicted one of the plural predefined logic-types from the reference statement using a text-based classifier; and
concatenating the predicted one of the plural predefined logic-types to the tabular training data.

6. The method of claim 5, wherein the training comprises:
using the model to create a generated statement from the tabular training data annotated with the predicted one of the plural predefined logic-types;
determining a loss based on comparing the generated statement to the reference statement; and
adjusting the model based on the loss.

7. The method of claim 4, wherein the plural predefined logic-types comprise count, comparative, superlative, unique, ordinal, aggregation, and majority.

8. The method of claim 1, wherein the model comprises an artificial neural network trained using cross entropy loss.

9. The method of claim 1, further comprising:
receiving the first input from a user device; and
causing the user device to display the first logic-type-specific natural language statement in response to the first input.

10. The method of claim 1, further comprising:
receiving the second input from a user device; and
causing the user device to display the plural second logic-type-specific natural language statements in response to the second input.

11. A computer program product comprising one or more computer readable storage media having program instructions collectively stored on the one or more computer readable storage media, the program instructions executable to:
train a model to generate one or more logic-type-specific natural language statements based on tabular data;
in response to receiving a first input comprising first input data with a user-specified logic-type, the trained model generating a first logic-type-specific natural language statement based on the first input data and the user-specified logic-type; and
in response to receiving a second input comprising second input data without a user-specified logic-type, the trained model generating plural second logic-type-specific natural language statements based on the second input data, wherein respective ones of the second logic-type-specific natural language statements are generated according to respective ones of plural predefined logic-types.

12. The computer program product of claim 11, wherein the model comprises a table-to-text (T2T) generation model that provides type control and semantic diversity.

13. The computer program product of claim 11, wherein training the model comprises:
annotating tabular training data with a predicted one of the plural predefined logic-types predicted from a reference statement;
using the model to create a generated statement from the tabular training data annotated with the predicted one of the plural predefined logic-types;
determining a loss based on comparing the generated statement to the reference statement; and
adjusting the model based on the loss.

14. The computer program product of claim 11, wherein the plural predefined logic-types comprise count, comparative, superlative, unique, ordinal, aggregation, and majority.

15. The computer program product of claim 11, wherein the model comprises an artificial neural network optimized using Adam optimizer.

16. A system comprising:
a processor set, one or more computer readable storage media, and program instructions collectively stored on the one or more computer readable storage media, the program instructions executable to:
train a model to generate one or more logic-type-specific natural language statements based on tabular data;
in response to receiving a first input comprising first input data with a user-specified logic-type, the trained model generating a first logic-type-specific natural language statement based on the first input data and the user-specified logic-type; and
in response to receiving a second input comprising second input data without a user-specified logic-type, the trained model generating plural second logic-type-specific natural language statements based on the second input data, wherein respective ones of the second logic-type-specific natural language statements are generated according to respective ones of plural predefined logic-types.

17. The system of claim 16, wherein the model comprises a table-to-text (T2T) generation model that provides type control and semantic diversity.

18. The system of claim 16, wherein the training the model comprises:
annotating tabular training data with a predicted one of the plural predefined logic-types predicted from a reference statement;
using the model to create a generated statement from the tabular training data annotated with the predicted one of the plural predefined logic-types;
determining a loss based on comparing the generated statement to the reference statement; and
adjusting the model based on the loss.

19. The system of claim 16, wherein the plural predefined logic-types comprise count, comparative, superlative, unique, ordinal, aggregation, and majority.

20. The system of claim 16, wherein the model comprises a transformer neural network.
